(19) United States
(12) Patent Application Publication
(10) Pub. No.: US 2007/0044855 A1
(43) Pub. Date: Mar. 1, 2007

(54) Counterpole self-sealing poppet valve

(76) Inventor: Eng-Hao Hong, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/452,485

(22) Filed: Jun. 14, 2006

(30) Foreign Application Priority Data
Aug. 30, 2005 (CN) 94214914

(51) Int. Cl. F16K 31/00

(52) U.S. Cl. 137/614.21

(57) ABSTRACT

A gas/fluid control device includes a valve body, a first poppet and a second poppet, a first lever and a second lever, and an actuator. The valve body has a chamber inside thereof, has passages at opposite sides of the chamber communicable with the chamber, and has a poppet seat around an end of each passage. The first poppet and the second poppet correspond to respective poppet seats in the chamber. The first lever and the second lever respectively connect to the first poppet and the second poppet. The actuator locates above the diaphragm and connects to the first and second levers.

### BACKGROUND OF INVENTION

1. Field of the Invention

The present invention relates to a gas/fluid control device, and more specifically, to a valve unit for control the flow of either liquid of gaseous media.

2. Background Art

Conventionally, a valve has a single poppet to allow/cease the flow of media through a flow passage of the valve. To stop the media from flowing through the valve, an extensive force using a spring, pneumatic pressure, electromagnet, electromechanical device, mechanical screw or mechanical lever is needed to apply to the poppet to create a seal over the flow passage. A head of the poppet sticks into the media path while a body of the poppet where the extensive force is applied block the flow of the media.

U.S. Pat. No. 7,004,446 teaches a valve unit having a permanent magnet actuator mechanism for displacement of a valve member between an open position and a closed position.

U.S. Pat. No. 7,032,876 discloses a valve for controlling fluid flow. The valve includes a support element providing a flow path, at least a portion of the flow path extending along an axis of flow through the valve. A flexible element is compressible against the support element to interrupt the flow path and restrict fluid flow through the valve. An actuating element is movable along the axis of flow to engage and deform the flexible element against the support element.

The inventor has investigated a gas/fluid control device that provides more precise control of the media flow, with minimum external force.

### SUMMARY OF THE INVENTION

It is therefore an object of the present invention to provide a gas/fluid control device in which minimum external force is needed for highly precise control of the media flow.

To achieve the object, the invention provides a gas/fluid control device that includes:
a valve body, having a chamber inside thereof, having passages at opposite sides of the chamber communicable with the chamber, and having a poppet seat around an end of each passage;
a first poppet and a second poppet, corresponding to respective poppet seats in the chamber;
a first lever and a second lever, respectively connecting to the first poppet and the second poppet; and
an actuator, locating above the diaphragm and connecting to the first and second levers.

The first and second poppets are disposed opposite to each other, with their sealing surfaces facing towards the respective poppet seats.

A diaphragm is disposed to define the chamber that keeps the media sealed within the valve body when the poppets are at close position.

In one aspect of the invention, each of the first lever and a second lever has one end disposed below the diaphragm and extending into the chamber. The other end of each lever is disposed above the diaphragm for engagement with the actuator for the control of the first poppet and the second poppet to rest on or leave from the corresponding poppet seats.

In another aspect of the invention, the first lever and the second lever straightly extend through the diaphragm to connect to the respective poppets so as to control the closing or opening of the passages by moving the first poppet and the second poppet toward or backward the respective poppet seats.

The actuator can be manually, pneumatically, mechanically or electrically powered.

### BRIEF DESCRIPTION OF THE INVENTION

The present invention may be more readily described with reference to the accompanying drawings, in which:

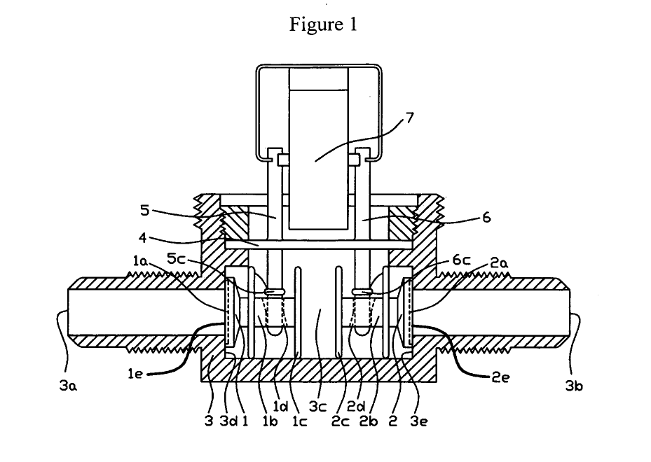

FIG. 1 is a longitudinal sectional view of a gas/fluid control device according to one preferred embodiment of the invention.

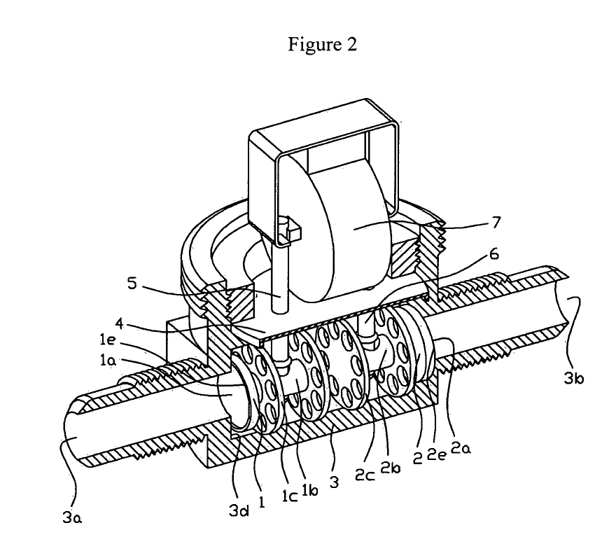

FIG. 2 is a three dimensional sectional view of a gas/fluid control device according to one preferred embodiment of the invention.

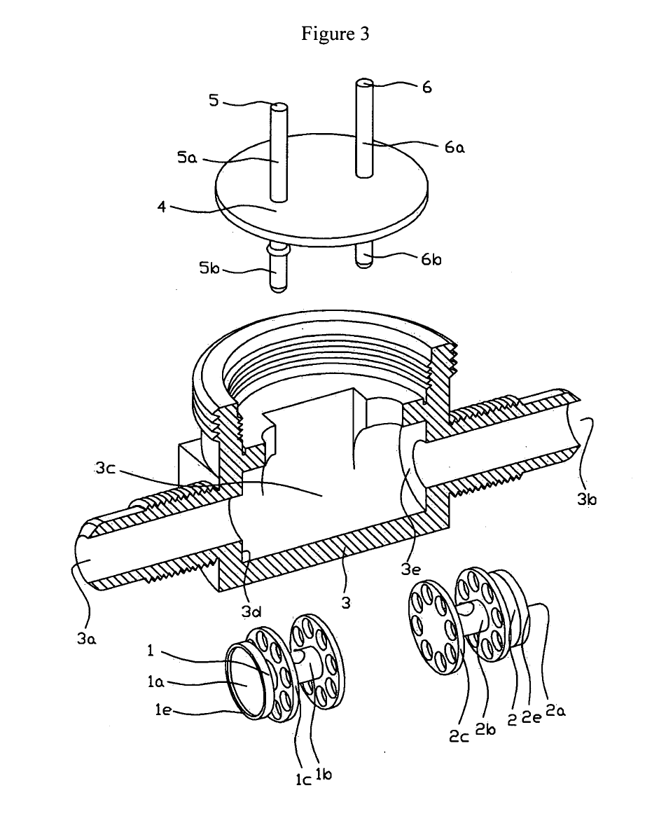

FIG. 3 is an exploded view of a gas/fluid control device according to one preferred embodiment of the invention.

### DETAILED DESCRIPTION OF THE PREFERRED EMBODIMENTS

Hereinafter, a detailed description is given of embodiments of the invention with reference to the drawings.

In one preferred embodiment of the invention, a gas/fluid control device for controlling the flow of media, for example, liquid chemical or gas, by opening and closing the passages includes a valve body, a first poppet and a second poppet, a first lever and a second lever and an actuator. The valve body has a chamber inside thereof, passages at opposite sides of the chamber communicable with the chamber, and a poppet seat around an end of each passage. The first poppet and the second poppet respectively correspond to the poppet seats in the chamber. The first lever and a second lever are configured to connect to the first and second levers.

FIG. 1 is a longitudinal sectional view of a gas/fluid control device according to one preferred embodiment of the invention. FIG. 2 is a three dimensional sectional view of a gas/fluid control device according to one preferred embodiment of the invention, and FIG. 3 is an exploded view of a gas/fluid control device according to one preferred embodiment of the invention.

As shown in FIGS. 1, 2 and 3, a gas/fluid control device of the invention is in normally close configuration. The term “media” here refers to any kind of media such as gas and fluid, regardless of their concentrations, consistency, color or other physical properties.

Valve Body

The valve body has a casing with two lengthwise flow passages (3a, 3b) at either side. Two cylindrical poppets (1, 2) are oppositely disposed inside a chamber (3c) that is inside the casing and defined by a diaphragm (4) above and inner sidewalls of the valve body. The poppets (1, 2) can slide freely towards or away from poppet seats (3d, 3e) on interior walls of the chamber (3c) around the passages (3a, 3b). The chamber (3c) can be of any shape as long as it can accommodate the poppets. For example, the chamber is of one of round, polygon or other shapes.

When the poppets (1, 2) is in open position, i.e. leave from the poppet seats (3d, 3e), the media flows into the chamber from one passage and out through the other passage.

On the other hand, when the poppet (1, 2) is in close position, i.e. rest on the poppet seats (3d, 3e), the media outside the gas/fluid control device stops entering into the chamber (3) while the media that enters before one of the poppets closes is sealed within the chamber (3c).

(Poppets)

The poppets (1, 2) are of cylindrical shape, and has sealing surfaces (1a, 2a) respectively facing the corresponding poppet seats (3d, 3e). The sealing surfaces (1a, 2a) have a ridged circumference so that they seat flatly against the poppet seats (3d, 3e) to create a seal over the passages. Two wheel-like discs (1c, 2c) are disposed opposite to the sealing faces (3d, 3e) to move along the axial direction of the axles (1b, 2b), keeping the poppets (1, 2) centered within the chamber (3c). The discs (1c, 2c) respectively have multiple borings that allow the media to flow through. The axles have offset bores (1d, 2d) that allow the levers to angle while keeping the axles horizontal during actuation. Preferably, each of the poppets (1, 2) is made solid homogeneous.

Media flow stops as long as the total force exerted on the rear of sealing surfaces of the poppets by the media and the levers is greater than that by the media itself on the sealing surfaces of the poppets. To stop media from flowing in reverse direction when the valve is in a close position, two poppets are forced against the respective poppet seats opposite each other and along the media path.

(Diaphragm and Lever)

The diaphragm (4) locates inside the body (3) to define the chamber (3c) that serves to keep the media within the chamber (3c) when the poppets (1, 2) are in close position.

The levers (5, 6) respectively have first ends (5a, 6a) extending above the diaphragm (4) and second ends (5b, 6b) extending below the diaphragm (4). The second ends (5b, 6b) penetrate perpendicularly through axles (1b, 2b) of the poppets (1, 2). The levers have protruded stoppers (5c, 6c) to keep the poppets in horizontal position when actuated. The levers (5, 6) move the poppets (1, 2) towards or away from poppet seats (3d, 3e) by the power of the actuator (7).

(Actuator)

The actuator (7) is an illustrative example that can be used to configure the gas/fluid control device of the invention as normally close or normally open. It can be any type of device that is manually, pneumatically, mechanically or electrically. It can be put into practice without any change of arrangement or configuration of the poppets, the valve body, the diaphragm and the levers.

When the gas/fluid control device is to be opened, the actuator (7) drives the levers (5, 6) to move the poppets (1, 2) away from the poppet seats (3d, 3e), so that the media flow through the chamber (3c). On the other hand, when the gas/fluid control device is to be closed, the actuator (7) drives the levers (5, 6) to move the poppets (1, 2) toward the poppet seats (3d, 3e). When the poppets (1, 2) rest on the poppet seats (3d, 3e), the media pressure push the poppets (1, 2) further against the poppet seats (3d, 3e). In addition to the external force exerted by the actuator, hydraulic force from the media on the rear of the poppets helps to further push the poppets against the respective poppet seats, thus making the seal on each passage much tighter and stopping the media inside the chamber (3c) from leakage. By utilizing the hydraulic force, smaller force from the actuator is needed and more precise control of the flow is provided, compared to those using no hydraulic force.

In one embodiment, the poppets are solid homogeneous pieces. The valve body is also one solid homogeneous piece. The diaphragm together with the two levers is integrally made into a solid homogeneous piece. In another embodiment, the diaphragm/lever is made from any suitable flexible polymer or elastomer.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A gas/fluid control device, comprising:
a valve body, having a chamber inside thereof, having passages at opposite sides of the chamber and communicable with the chamber, and having a poppet seat around an end of each passage;
a first poppet and a second poppet, corresponding to respective poppet seats in the chamber;
a first lever and a second lever, respectively connecting to the first poppet and the second poppet; and
an actuator, locating above the diaphragm and connecting to the first and second levers.

2. The gas/fluid control device of claim 1, further comprising a diaphragm configured to define the chamber in which the media is kept.

3. The gas/fluid control device of claim 1, wherein each of the first lever and a second lever has a first end disposed below the diaphragm and extending into the chamber, and a second end oppositely disposed above the diaphragm.

4. The gas/fluid control device of claim 1, wherein the first lever and the second lever straightly extend through the diaphragm.

5. The gas/fluid control device of claim 1, wherein the first and second poppets are disposed opposite each other, with their sealing surfaces facing towards the respective poppet seats.

6. The gas/fluid control device of claim 1, wherein each of the poppets further comprises a wheel-like disc on one end of axle thereof opposite to the sealing surfaces.

7. The gas/fluid control device of claim 6, wherein the discs respectively have multiple borings to allow the media to flow through.

8. The gas/fluid control device of claim 6, wherein the axles have offset bores for the levers to angle while keeping the axles horizontal during actuation.

9. The gas/fluid control device of claim 1, wherein each of the poppets is made solid homogeneous.

10. The gas/fluid control device of claim 1, wherein the diaphragm together with the two levers is integrally made into a solid homogeneous piece.

11. The gas/fluid control device of claim 1, wherein the diaphragm and lever are made from any suitable flexible polymer or elastomer.

12. The gas/fluid control device of claim 1, wherein the actuator is manually, pneumatically, mechanically or electrically powered.
